(19) United States
(12) Patent Application Publication
(10) Pub. No.: US 2009/0061392 A1
(43) Pub. Date: Mar. 5, 2009

(54) Early Detection of Damage to Units Used in the Oral Cavity

(76) Inventor: Alexander Scholz, Kirchweidach (DE)

Correspondence Address: D. PETER HOCHBERG CO. L.P.A., 1940 EAST 6TH STREET, CLEVELAND, OH, 44114, US

(21) Appl. No.: 12/224,072

(22) PCT Filed: Feb. 14, 2007
(86) PCT No.: PCT/EP2007/001293

§ 371 Date: Oct. 6, 2008

(30) Foreign Application Priority Data
Feb. 16, 2006 (DE) 10 2006 007 335.5

(51) Int. Cl. A61C 9/00

(52) U.S. Cl. 433/215; 433/71

(57) ABSTRACT

A unit to be arranged in the oral space, which unit can, in particular, be a diagnosis and/or therapeutic treatment device. If the external shell of a unit of this type gets damaged, there is a risk of parts of the external shell detaching or of harmful substances leaking from the interior of the unit. In order to detect damage of this type as early as possible, the unit is provided with an indicator substance that is enclosed within the external shell and can be detected outside of the external shell in case the external shell breaks. The use of edible bitter substances for detecting damage on diagnostic and/or therapeutic units used in the oral spaces as well as to the use of edible dyes for detecting damage on diagnostic and/or therapeutic units used in the oral space are also provided. The dye is provided on the interior of the corresponding unit to leak out in case the corresponding unit gets damaged.

The present invention is related to a diagnostic and/or therapeutic unit to be arranged in the oral space, and in particular to the early detection of damage on units of this type.

In the course of diagnostic or therapeutic procedures, for example for the treatment of bruxism, it is common to arrange external units in the oral space and attach them therein, if applicable.

Teeth grinding or pressing together the teeth, called bruxism in the technical jargon, causes enormous suffering in 8.2% of the adult population. The causes are stress or inaugural factors. Teeth grinding leads to strong muscle tenseness in combination with headache up to severe damage to the chewing joints and teeth. No effective therapies are known at this time. Thus far, bruxism patients have been managed with a dental guard splint for preservation of their teeth and chewing joints although it is difficult to determine in which patients and when this measure is required and whether or not it actually leads to success. An individualized dental guard splint of this type is fabricated by a dental technician by means of a dentition impression. The guard splint is then to be used by the patient at night and, in severe cases, during the day also.

Aside from solely mechanical dental guard splints for preservation of the teeth, guard splints have been developed in which sensors for measuring the occlusion pressure are arranged whose measured values are transmitted to an analytical unit by cable or via a telemetry path.

Since bruxism patients often exert an excessive tooth pressure involuntarily in their sleep, U.S. Pat. No. 5,078,153, U.S. Pat. No. 5,490,520, EP 0 654 981 B1, and U.S. Pat. No. 5,586,562 proposed systems that are to be used by the patient at night and in which the dental guard splint is fitted with measuring probes measuring the occlusion pressure. An analytical unit is provided that supplies a warning signal to the patient if a predetermined pressure value is exceeded in order to induce the patient to relax the chewing muscles.

Aside from bite guard splints of this type, there are a number of other units in medical technology, and in particular in dental technology, that are arranged in the oral space and fixed therein, if applicable, such as, e.g., braces, dental prostheses, and artificial teeth. In these cases, there is always the risk that a unit of this type may come loose off its attachment, that the attachment comes loose or that the unit itself is damaged, for example is fractured.

If the unit provided in the oral space contains further electrical components, such as is the case, for example, in bite guard splints, that are used for detection and, if applicable, therapy of bruxism, a unit of this type getting damaged may lead to exposure to the components of the electrical circuiting than usually comprise substances that are a health hazard.

Even if the unit to be used in the oral space is a solely mechanical element, such as, for example, a passive bite guard splint or a dental prosthesis containing no substances that are hazardous to man according to the current state of knowledge, such as, e.g., copper, heavy metals or acids, there is the risk that fracture of the unit to be provided in the oral space may cause some of its material to chip off which can lead to injury of the patient.

In order to prevent injury and intoxication of people, units of this type must therefore be manufactured to be break-proof or it must be ensured that swallowing the foreign body does not necessarily lead to damage to the patient. If, in addition, toxic substances were contained in the interior of the respective unit, it would need to be ensured that these cannot enter into the body of the patient.

It is therefore the object of the present invention to provide a diagnostic and/or therapeutic unit to be arranged in the oral space, by means of which the risk resulting from fracture of a unit of this type of detrimentally affecting the patient by exposure to ingredients or by swallowing of parts of a damaged unit can be minimized further.

This object is met according to the invention in that a diagnostic and/or therapeutic unit to be arranged in the oral space that is provided with an external shell has an indicator substance enclosed into the external shell which indicator substance is detectable outside of the external shell in the case of the external shell getting damaged. By this means, the patient or treatment provider can be warned as rapidly as possible as soon as the unit arranged in the oral space is damaged such that countermeasures can be undertaken immediately.

As mentioned above, fractures, fissures, and damage can occur during the manufacture and during the use of bite guard splints, dental prostheses, and braces. Moreover, the dentist or the dental technician might damage the bite guard splints, dental prostheses, and artificial teeth, in the course of processing, e.g. in the course of grinding-in. This is of significance especially if electronic components or other toxic components are contained on the interior of the bite guard splints, dental prostheses, and artificial teeth.

On the one hand, damage to a unit of this type, e.g. a bite guard splint, may lead to a malfunction. On the other hand, toxic substances (e.g. heavy metals or acids) may leak into the body or fragments may be swallowed.

The indicator substance provided according to the invention allows for early detection of fractures, fissures, and damage and might therefore prevent the unit from breaking apart completely and therefore the ensuing inadvertent swallowing of parts thereof.

Preferred developments of the invention are evident from the sub-claims.

In particular, an edible bitter substance can be provided as indicator substance. Bitter substances are substances that convey to the patient a very bitter taste as soon as they are exposed to saliva. These substances are available in the form of a powder or in liquid form. Bitter substances with low viscosity are also available. Examples to be mentioned here are glucosinolates which are secondary plant substances that convey the somewhat bitter taste to vegetables such as white radish, mustard, cress, and cabbage. Glucosinolates are sulfurous molecules that are formed from amino acids and occur predominantly in crucifers. There are approximately 120 different types that differ from each other only in their aglucon residue. Myrosinase is the cleavage enzyme of the glucosinolates. This enzyme is present in the cells, albeit spatially segregated, and leaks during chewing or cutting. A further example of a suitable bitter substance for use as an indicator substance in the unit to be arranged in the oral space is cynarine, which is a liver-friendly bitter substance that is beneficial for the gastric mucosa and also has a digestion-promoting effect and is suitable as a bitter substance for indication purposes.

Aside from bitter substances, a dye can be provided as indicator substance, in particular an edible dye. Edible dyes that spread noticeably when exposed to water and may even change their color in the process are particularly suitable. When rinsed under running water, even minute quantities are sufficient to change the color of the water. These substances are available in the form of a powder or in liquid form. Dyes with a low viscosity are also available.

Indigotine (also called indigo carmine) shall be mentioned as an example in this context. Indigotine, E 132, is a blue foodstuff dye that is also used in combination with yellow dyes to produce a green color. Indigotine is water soluble and stable at temperatures up to 150° C. Indigotine is non-hazardous for man and often used for coloring alcohol free beverages, liqueur, sweets, ice cream, pasta, and sugar-coated tablets.

Edible dyes (e.g. iron) that change color when exposed to air can be used also. These substances are also available in the form of a powder or in liquid form with dyes of low viscosity also being available.

It is self-evident that a plurality of different indicator substances can be used in the interior of the unit, e.g. a combination of dyes and bitter substances, to allow both the patient and the therapist to detect any damage of the unit as rapidly as possible.

As mentioned above, the unit to be arranged in the oral space can be designed as a bite guard splint for treatment of a bruxism patient. In this context, the bite guard splint can be designed as a solely mechanical element, in particular as an occlusal splint, repositioning or decompression splint, or an electronic arrangement can be provided on the interior of the bite guard splint. For example, the electronic arrangement can comprise pressure sensors for measuring the bite pressure, whereby, in addition, a power supply, in particular a rechargeable power source, an analytical unit, an output unit, etc., may be provided.

Aside from units of this type that have components arranged on their interior that are detrimental to the body, the concept described herein is also suitable for solely mechanical components, such as, for example, dental prostheses that can be provided in particular as removable or fixed dental restorations, for example as dental crown, dental bridge, temporary insert or implant. In units of this type, damage can be detected early by means of the indicator substance provided according to the invention such that complete failure of the unit, for example breaking apart completely, which might have unpleasant or even detrimental consequences for the patient, can be detected as rapidly as possible or even prevented altogether.

In further development of the invention, there may be provided within the external shell a layer for taking-up the indicator substance, which layer binds the indicator substance for as long as the external shell of the unit is intact. In this context, the layer can be designed in the form of a textile, woven cloth, film or paper layer into which the indicator substance is soaked up or to which the indicator substance adheres.

Moreover, a layer can be provided within the external shell, which layer prevents the unit from falling apart if the external shell gets damaged, whereby the layer binding the indicator substance preferably is identical to the layer preventing the unit from falling apart if the external shell gets damaged.

Aside from the units illustrated above, the invention is also related to the use of edible bitter substances for detecting damage on diagnostic and/or therapeutic units that are used in the oral space, as well as to the use of edible dyes for detecting damage on diagnostic and/or therapeutic units that are used in the oral space, in which the dye is provided on the interior of the respective unit to leak out in case the respective unit gets damaged.

And finally, the present invention is related to a method for treatment of toxic or swallowable components that are part of a diagnostic and/or therapeutic unit to be arranged in the oral space and are arranged within an external shell of the unit, whereby the components are covered in the course of the method with an indicator substance that can be detected outside the external shell in case the external shell gets damaged.

In this context, the toxic or swallowable components can be covered, spanned, coated or connected otherwise by a textile, woven cloth, paper or film layer that binds the indicator substance for as long as the external shell of the unit is intact, for example by means of a textile layer soaked in the indicator substance, or the indicator substance can be applied, for example sprayed, directly to/onto the toxic or swallowable components.

The indicator substances specified above, i.e. edible bitter substances and dyes, are used in the course of this method.

The invention is illustrated in more detail in the following with reference being made to the appended drawings. In the figures:

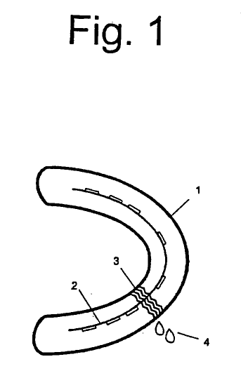

FIG. 1 shows a bite guard splint for diagnosis and treatment of bruxism;

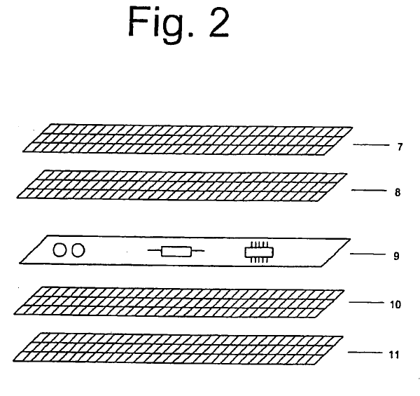

FIG. 2 shows a schematic view of the layers used on the interior of a modified embodiment of the bite guard splint shown in FIG. 1;

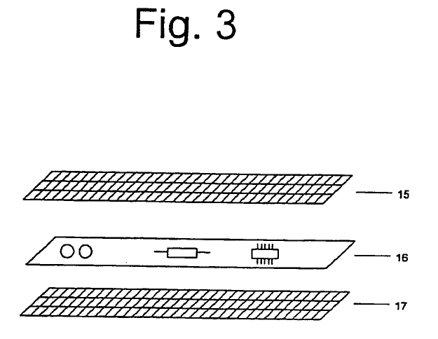

FIG. 3 shows a schematic view of a modified embodiment of the layer structure shown in FIG. 2; and

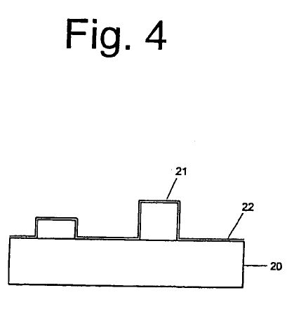

FIG. 4 shows a schematic view of a modified embodiment, in which the indicator substance was applied directly to the components that are arranged on the interior of the unit.

FIG. 1 shows a bite guard splint (1) that is used for diagnosis and treatment of bruxism (“teeth grinding”). The apparatus can, in addition, be provided with a measuring sensor system and electronics (2) for detecting, e.g., the tooth occlusion pressure, temperature, humidity, quantity of saliva, acoustic pressure, teeth grinding, and other medically relevant data. Preferably, in addition, another telemetry unit (not shown) is provided for wireless transmission of data detected by the measuring sensor system (2) to the outside where this data can be saved and passed-on to the physician in charge.

A telemetric bite guard splint that is provided with sensors allows the forces occurring in bruxism to be measured conveniently and in real-time. In this case, there is no longer a need to attach inconvenient electrodes to the face of the patient or examine the patient in the sleep laboratory.

This allows for both diagnosis and follow-up observations to be performed in the familiar home environment of the patient without affecting the sleep quality of the patient and therefore the measuring result. A system of this type allows to develop new bruxism therapies or evaluate existing therapies. In this context, an integrated bio-feedback system by means of vibrating alarm allows for efficient bruxism therapy.

In order to protect the patient, it must be ensured that the components of the electronics (2) that are incorporated into the dental guard splint (1), some of which contain harmful substances like heavy metals and acids, cannot enter into the body in case a fracture, fissure or other damage to the bite guard splint occurs.

For this purpose, at least one indicator substance is introduced into the splint, whereby said indicator substance leaks in case a fracture, fissure or other damage occurs or if it is exposed to saliva (4) or oxygen entering at the defective site. The indicator substance can, in particular, be a bitter substance or a dye that changes color when exposed to water or air. Accordingly, a fissure can be detected by means of a bitter taste experienced by the patient or by the water having a changed color when the device is rinsed.

A variant of the embodiment according to FIG. 1 is shown in FIG. 2. The aim is, on the one hand, to draw attention to fractures, fissures, and damage and, on the other hand, to protect the bite guard splint from breaking apart completely. To provide protection from breaking apart completely, textiles, woven cloths, films and/or papers (8), (10) are used that are affixed below and above the plate (9). In this context, the task of the textiles, woven cloths, films and/or papers (8), (10) is to provide protection from breaking apart completely. The textiles, woven cloths, films and/or papers (8), (10) are characterized by their very high tear resistance.

In addition, textiles, woven cloths, films and/or papers (7), (11) are affixed for the detection of fractures, fissures, and damage. These textiles, woven cloths, films and/or papers (7), (11) are characterized by their indicator function which is being realized in that the corresponding layer (7), (11) is soaked in indicator substance or in that the indicator substance adheres to the layer.

In the variant according to FIG. 3, the textile, woven cloth, film and/or paper layers (7) and (8) as well as (10) and (11) of FIG. 2 are combined into a single textile, woven cloth, film and/or paper layer (15) and/or (17). Affixed below and above the plate (16), the layers (15) and (17) serve the dual function of, on the one hand, protecting the unit containing the plate (16) from breaking apart completely and, on the other hand, of binding the at least one indicator substance. In this context, the textile, woven cloth, film and/or paper layers (15), (17) are realized by materials that are both absorbent and tear-resistant.

FIG. 4 shows a variant, in which the indicator substance or the indicator substances (22) are applied directly to the plate (20) and cover both the components (21) and the plate (20).

1. A diagnostic and/or therapeutic unit arranged in the oral space, said diagnostic and/or therapeutic unit comprising an external shell, having an indicator substance that is enclosed in the external shell and can be detected outside of the external shell in the event of damage to the external shell.

2. The unit according to claim 1, wherein the indicator substance is an edible bitter substance.

3. The unit according to claim 1, wherein the indicator substance is a dye.

4. The unit according to claim 3, wherein the indicator substance is an edible dye.

5. The unit according to claim 3, wherein the indicator substance is a dye that changes color when exposed to water.

6. The unit according to claim 3, wherein the indicator substance is a dye that changes color when exposed to air.

7. The unit according to claim 1, wherein said unit is designed as a bite guard splint for treating a bruxism patient.

8. The unit according to claim 7, further comprising an electronic arrangement on the interior of the bite guard splint.

9. The unit according to claim 1, wherein said unit is designed as a brace for correcting jaw and/or tooth malposition.

10. The unit according to claim 1, wherein the unit is provided as a dental prosthesis.

11. The unit according to claim 1, further comprising a layer within the external shell for binding the indicator substance for as long as the external shell of the unit is intact.

12. The unit according to claim 11, wherein the layer is selected from the group consisting of a textile layer, a woven cloth layer, a film layer and a paper layer.

13. The unit according to claim 1, further comprising a layer within the external shell for preventing the unit from breaking apart in case the external shell gets damaged.

14. The unit according to claim 13, wherein the layer binding the indicator substance for as long as the external shell of the unit is intact is identical to the layer preventing the unit from breaking apart in case the external shell gets damaged.

15. Use of edible bitter substances for detecting damage on diagnostic and/or therapeutic units that are used in the oral space.

16. Use of edible dyes for detecting damage on diagnostic and/or therapeutic units that are used in the oral space, wherein the dye is provided on the interior of the respective unit for leaking out in case the respective unit gets damaged.

17. The use according to claim 16, wherein the dye is selected from the group of dyes that change color when exposed to water or air.

18. The use according to claim 17, wherein the dye is indigotine.

19. A method for treating toxic or swallowable components that are part of a diagnostic and/or therapeutic unit to be arranged in the oral space and are arranged within an external shell of the unit, said method comprising the step of covering the components with an indicator substance that can be detected outside of the external shell in case the external shell gets damaged.

20. The method according to claim 19, comprising the step of covering, spanning, coating or connecting the toxic or swallowable components by a layer selected from the group consisting of a textile layer, a woven cloth layer, a paper layer and a film layer that binds the indicator substance for as long as the external shell of the unit is intact.

21. The method according to claim 19, comprising the step of applying the indicator substance directly to the toxic or swallowable components.

22. The method according to claim 19, wherein the indicator substance is an edible bitter substance.

23. The method according to claim 22, wherein the indicator substance is an edible dye.
